(19) United States
(12) Patent Application Publication
(10) Pub. No.: US 2016/0313209 A1
(43) Pub. Date: Oct. 27, 2016

(54) SMART UTILITY TOWER/POLE MONITORING SYSTEM

(71) Applicants: Ryan Van Zee, Sioux Falls, SD (US); Todd Christensen, Baltic, SD (US)

(72) Inventors: Ryan Van Zee, Sioux Falls, SD (US); Todd Christensen, Baltic, SD (US)

(21) Appl. No.: 14/695,366

(22) Filed: Apr. 24, 2015

(51) Int. Cl. G01M 5/00; E04C 3/30; E04H 12/00

(52) U.S. Cl. CPC G01M 5/0025; G01M 5/0066; G01M 5/0033; E04H 12/00; E04C 3/30

(57) ABSTRACT

A utility tower/pole monitoring system having a plurality of monitoring devices mounted to a plurality of utility tower/poles. The monitoring devices include an accelerometer, gyroscope, and a GPS device. The monitoring devices transmit acceleratory and positional data to a data aggregation system for processing and storage. The data aggregation system displays status data on a map on a website that is easily accessible and downloadable by an end user such as a lineman.

### BACKGROUND OF THE INVENTION

This invention is directed toward a utility tower/pole monitoring system, and more particularly to a system that monitors positional and acceleratory data of utility towers/poles and other free standing structures.

Utility pole monitoring systems are known in the art. The most basic system involves having an individual make a visual observation of a pole to determine if the pole is leaning or down. Other systems utilize tilt sensors. While helpful, these sensors are not as precise in measuring oscillation and wind forces encountered by the poles. This information is useful as it provides an indication of a pole that may need maintenance prior to a problem developing. Therefore, a need exists in the art for a system that addresses these deficiencies.

An objective of the present invention is to provide a monitoring system that provides acceleratory data.

A further objective of the present invention is to provide a system that displays easily accessible data.

These and other objectives will be apparent to those of ordinary skill in the art based upon the following written description, drawings and claims.

### SUMMARY OF THE INVENTION

A utility tower/pole monitoring system having a plurality of monitoring devices mounted to a plurality of utility tower/poles. The monitoring devices have a case that houses electronic components. Disposed within the case are mounting pads to which a control board and communication card are connected. An accelerometer and a GPS device are connected to the control board for providing acceleratory and location/positional data.

The communication card transmits data to a data aggregation system. The data aggregation system includes a server having software and a database that is connected to a website. The data system is capable of displaying status data and alerts on a map on the website and providing historical data for analysis.

### BRIEF DESCRIPTION OF THE DRAWINGS

FIG. 1 is a schematic view of a utility tower/pole monitoring system; and

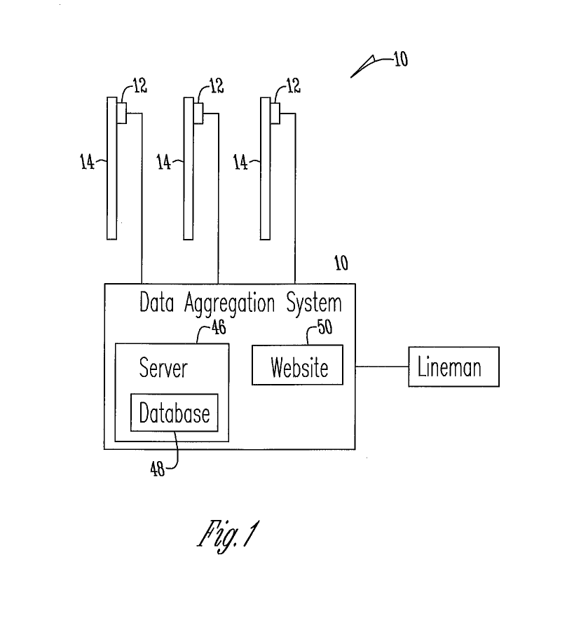

FIG. 2 is a front view of a monitoring device.

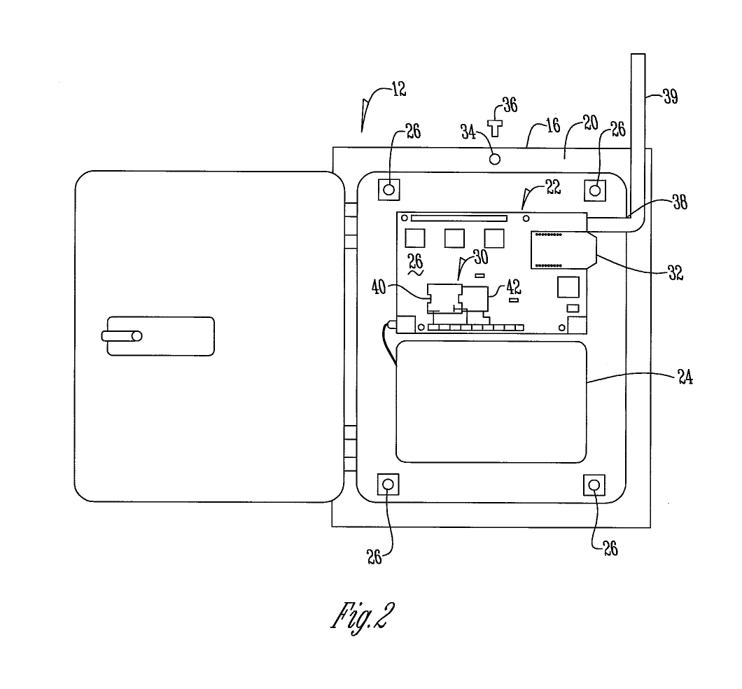

### DETAILED DESCRIPTION OF THE PREFERRED EMBODIMENTS

Referring to the Figures a utility tower/pole monitoring system 10 includes a plurality of monitoring devices 12 mounted to the top of a plurality of utility poles 14. The monitoring device 12 includes a case 16 that is preferably made of plastic and preferably having a lockable door 18. The case 16 provides a weather-proof and shock resistant environment for electrical components to operate.

Disposed within the case 16 are mounting pads 20 to which the main controller board 22 and power supply 24 are fastened. The microcontroller board 22 is anchored to the back of the case 16 with screws 26 or the like.

The microcontroller board 22 includes a processor 26 that houses logic/software that reads information from sensors 30 and sends the information to a communication card 32 which transmits the information over a specified channel of communication. The power supply 24 is of any type such as a battery unit or other power source that supplies the controller board 22 and other electrical components with the power need to carry out assigned processes. The power supply 24 is anchored to the mounting pad 20 with screws 26 and is wired to the control board 22 or connected to a power port using a jack. The communication card 32 is wired to or plugged into the main controller board 22.

The back of the case 16 has a plurality of holes 34 through which mounting hardware 36 passes to mount the monitoring device 12 to a tower/pole 14. There is also a hole 38 in a side of the case 16 through which an antenna 39, attached to the communication card 32, passes. The antenna 39 is wired to the communication card 32 and increases the device's 32 capacity for wireless communication especially in the presence of ice accumulation and extreme weather conditions.

One of the sensors 30 attached to or wired to the main controller board 22 is an accelerometer/gyroscope 40. The accelerometer 40 detects lateral changes in the tower/pole 14 as well as changes in orientation such as rotation. Another sensor is a GPS device 42 that provides the longitude and latitude of the monitoring device 12 and tower/pole 14.

Connected to the monitoring device 12 via an electronic network is a data aggregation system 44. The data system 44 includes a server 46 with a database 48 and a website 50 to display collected data preferably in a graphical map layout.

In operation, the longitude and latitude of each monitoring device is determined by the GPS device 42 and transmitted by the communication card 32 to the data system 44 where the location information is stored in the database 48. Alternatively, the location information is input into computer 46 and stored.

The accelerometer/gyroscope 40 continuously monitors both lateral and rotational changes in the position of the tower/pole. This information is transmitted to the data system 44 from the communication card 32. The computer 46 compares the transmitted information with the stored information and provides a status alert when a predetermined margin of change or difference has been exceeded. The most recent status information of the utility tower/pole 14 to which each monitoring device 12 is attached is then displayed on the website 50. This information is downloadable by a user to a mobile phone or other device. Historical data is also available for analytical purposes.

What is claimed is:

1. A utility tower/pole monitoring system, comprising:
a plurality of monitoring devices mounted to a plurality of poles, wherein each monitoring device has an accelerometer;
a data aggregation system having a computer, a database, and a website, wherein the data aggregation system is connected to the plurality of monitoring devices via an electronic network; and
the computer being capable of displaying location and acceleration data transmitted from the plurality of monitoring devices on the website.

2. The system of claim 1 wherein each monitoring device includes a case having mounting pads to which a control board and communication card are connected.

3. The system of claim 1 wherein each monitoring device has a GPS device capable of transmitting the location information of the monitoring devices and the utility poles to the data aggregation system.

4. The system of claim 1 wherein the server of the data aggregation system is capable of comparing information transmitted from the plurality of monitoring devices with information stored within the database and providing a status alert when a predetermined margin of change has been exceeded.
